(19) United States
(12) Patent Application Publication
(10) Pub. No.: US 2008/0018980 A1
(43) Pub. Date: Jan. 24, 2008

(54) ELECTRICALLY ACTIVE ELEMENT

(75) Inventors: Regine Niepmann, Sprockhoevel (DE); Olaf Knebel, Arnschwang (DE); Klaus Hoegerl, Furth Im Wald (DE)

Correspondence Address: DARBY & DARBY P.C., P.O. BOX 770, Church Street Station, New York, NY, 10008-0770, US

(73) Assignee: FLABEG GMBH & CO. KG, Furth Im Wald (DE)

(21) Appl. No.: 11/766,167

(22) Filed: Jun. 21, 2007

(30) Foreign Application Priority Data
Jun. 21, 2006 (DE) 10 2006 028 897.1

(51) Int. Cl. G02F 1/153; B60R 1/08

(52) U.S. Cl. 359/274; 359/265

(57) ABSTRACT

An electrically active element with an electrically selectable layer system arranged between a front wall and a back wall being realized as an adhesive tape with a multilayer carrier, which has at least one lower, and preferably one upper, film component, each of them consisting of at least one plastic film, as well as a metallic layer component arranged between the upper and lower film components, and which is provided on the outer surface of the lower film component with a glue material. For improved sealing of the electrically selectable layer system, the front wall and the back wall are connected with each other in a sealing manner in their margin areas by means of a number of sealing elements consisting of a sealing film which is more deformable than the back wall.

Priority is claimed to German Patent Application No. DE 10 2006 028 897.1, filed on Jun. 21, 2006.

The invention relates to an electrically active element with an electrically selectable layer system arranged between a front wall and a back wall, the back wall being realized as an adhesive tape with a multilayer carrier which has at least one lower film component consisting of at least one plastic film as well as a metallic layer component arranged on the lower film component, and which is provided on the outer surface of the lower film component with a glue material. It also relates to a motor-vehicle mirror provided with such an electrochromic element.

### BACKGROUND

Electrically active elements, in which a layer system arranged between two limiting walls is electrically selected to achieve specific effects, are used in many applications. For example, layer systems enclosed between two substrates, which change locally as a function of the respective selection of their optical properties, thus enabling a specific indication, can be used in displays or other indicating devices.

In particular, the phenomenon of an electrochemically induced spectroscopic change in a material, usually a change of color, is usually called electrochromism. Making use of this phenomenon, for example optical devices with variable transmission or reflection can be produced in which the reflectance or degree of transmission can be changed as a function of an applied voltage.

In such electrochromic elements, an electrochromic material interacts with guest ions or electrodes introduced into the electrochromic material by applying an electric potential, the interaction of the electrochromic material being influenced by means of the incidence of electromagnetic radiation. Typical examples of such electrochromic materials are WO₃ and MoO₃, which, when applied in thin lavers on a carrier, are almost colorless. If protons migrate into such a layer, for example in the case of tungsten oxide (WO₃), a reduction to blue tungsten bronze will take place, the intensity of the coloring being determined by the amount of the electrical charge flowing in the layer.

Electrochromic elements produced on the basis of this principle of electrochromism can be used in various devices in which a specific variability of the reflection or transmission characteristics is desirable. Such devices can be used, for example, in windows and canopy tops, in particular for motor vehicles. Such applications are, however, particularly advantageous for producing rearview mirrors with a low glaring effect for motor vehicles, because one problem of such rearview mirrors, which are usually designed for a particularly high reflectance in view of a good perceptibility in daylight, consists in the fact that at night, they can be very disturbing, in particular in view of a possible glare through following vehicles. Therefore, in view of the spectral distribution of the light emitted by the headlights of motor vehicles, an efficient antiglare behavior can be achieved in a particularly advantageous manner through an appropriate variation of the reflection characteristics of a rearview mirror by coating such a mirror with a suitably selected electrochromic material. In this case, on the one hand, a particularly high reflectance in daylight can be maintained, while in case of need, i.e. for example after a sensorically detected light incidence at night, the spectral reflection characteristics can specifically be modified by applying a control voltage, thus achieving an antiglare effect.

Especially in view of a possible use in a vehicle rearview mirror, it is desirable that such electrochromic instruments achieve with relatively short switching times a particularly high so-called reflection stroke, namely the difference between the reflection maximum and the reflection minimum. In this way, the achievable reduction of the glaring effect by applying the control voltage will be particularly high. Furthermore, electrochromic elements suitable for use in vehicle rearview mirrors should in general have a particularly long service life, in view of their global duration of use and the number of switching cycles.

In view of these requirements, however, an electrochromic element, concerning its efficiency and the like, depends in general in a relatively sensitive manner on the composition and in particular on possible pollutions, occlusions of gases or the like, in the usually applied electrochromic multilayer packages. Furthermore, influences of varying ambient parameters on the operation of the electrochromic layer package should be avoided as far as possible. Likewise, a penetration into the active layer system should also reliably be excluded in other embodiments of such electrically active elements, for example displays. Therefore, especially in case of applications in the field of motor-vehicle rearview mirrors, such elements are usually executed in a sealed manner, in order to avoid an undesired penetration of foreign ions, water, water vapor, other gases, solvents or the like, into the electrically active layer package or multilayer system. The desired tightness is usually achieved by arranging the multilayer system between a front plate and a back wall, both front plate and back wall being sufficiently tight for the application in question.

In order to enable a construction of such electrically active systems which is particularly advantageous for use in the field of motor vehicles, with a relatively low total weight and a relatively small depth of the component, even when complying with relatively high requirements as to the tightness of the encapsulation of the electrically active layer system, WO 2006067179 discloses an electrically active element of the above-mentioned type, in which the back wall is executed as an adhesive tape with a multilayer carrier which has at least one upper and one lower film component, each of them consisting of at least one plastic film, as well as a metallic layer component arranged between the upper and lower film components, and which is provided on the outside of the lower film component with a glue material. The content of the disclosure of this patent specification regarding type, nature and manufacture of the film used as back wall or of the adhesive tape used as back wall including the components and materials used therefor is expressly fully incorporated in the present disclosure by reference.

It turned out that an electrically active element realized in such a way has a sufficiently high tightness and long-time stability in the area of its back wall to guarantee a sufficiently long service life with sufficiently favorable switching properties, even for an application under everyday conditions, but especially in the area of the margin zones, an electrically active element realized in such a way is not sufficiently tight, so that, for example in so-called heat-storing tests, where the elements are stored at an ambient temperature of about 85° C., a drying-out from the margin is found. Especially in electrochromic elements of the above-mentioned type, a loss of switching speed and, later, also a loss of switching stroke, is found in a progressing margin zone, so that the electrically active element is suitable to a limited extent only for an application in large series, for example in the field of motor vehicles.

### SUMMARY OF THE INVENTION

It is an object of the invention to provide an electrically active element of the above-mentioned type which possesses an even more perfected sealing of the electrically selectable multilayer system arranged between the front wall and the back wall, against any occurring disturbing substances.

This problem is solved according to the invention by the fact that the front wall and the back wall are connected with each other in a sealing manner in their margin areas by means of a number of sealing elements consisting of a sealing film which is more deformable than the back wall.

By deformable, one understands here in particular that, through the choice of suitable parameters, i.e. for example, suitable materials, through a suitable structure, such as, for example, a layer structure and/or through a suitable dimensioning, such as, in particular, the choice of a suitable thickness, the scaling foil develops a deformation when the overall system consisting of the back wall and the sealing film is subjected to lateral fores, before the back wall does so. As a suitable parameter for the purpose, one can use in particular the product of the modulus of elasticity E of the sealing film or of the back all, which can be determined, for example, by means of a bending test according to the standard DIN 53452, and the third power of the thickness a³ of the sealing film. Advantageously, the product of these two variables E·a³ is at least to times smaller than the corresponding value of the back wall. This can be achieved, for example, by the modulus of elasticity of the sealing film being two times smaller and/or by a correspondingly reduced thickness in comparison with the back wall.

Furthermore, one can preferably understand by “deformable” also “permanently deformable”. It shall in particular be specifically guaranteed by a suitably chosen material and dimensioning of the sealing or margin-sealing film provided as a sealing element that due to the special deformability of said film, a permanent deformation develops during fitting or manufacturing of the element, which supports or at least does not hinder the desired sealing effect. For this purpose, the sealing film is advantageously chosen in such a way, especially in comparison with the relatively rigid back wall, that after folding over through loading with a test weight and subsequent release, it shows a developing aperture angle of not more than half of the aperture angle, preferably not more than one fifth, particularly preferably not more than one tenth, of the aperture angle of the back wall under comparable test conditions. In other words, the sealing film shall be constituted and dimension in such a way that after having been folded over about the margin area, it shows a clearly lower tendency to stand up again than the back wall, which is finally expressed in the before-mentioned aperture angle.

To verify these properties, the sealing film on the one hand and the back-wall material on the other hand can be subjected to a suitable laboratory test under otherwise identical test conditions. In such a laboratory test, for example, the liner of the adhesive tape can be removed from a test strip of the material to be examined, i.e. of the sealing film or of the back wall, of a specifiable dimension of, for example, 40 mm length and 9 mm width, over a length of 23 mm. Then, a strip of about 3 mm width and at least 9 mm length of the pulled off liner material can be separated and be applied on the glue material of the test strip in such a way that the test strip is provided with liner over a length of 20 mm and free of liner over a length of 20 mm. The test strip prepared in this way can then be glued with its exposed glue material on a glass plate in such a way that 15 mm of its portion provided with liner protrude over the margin of the glass plate. This portion can then be lifted and pulled in the direction of the glued-on portion of the strip, and then, a test weight of about 1500 g is put on obliquely from outside in such a way that the end of the glued-on portion of the test strip is folded over backwards. After the test weight has remained in this position during a load stage of at least about 5 minutes, it can be taken off upwards. Then, the 3 mm wide separate strip of liner can be pulled off the glue material without deformation of the test strip, so that the liner taken off in the folding area will not be upset while the test strip rises, thus hindering its rising. After a specifiable relaxation time of, for example, some minutes or some hours, the height of the risen free end of the test strip can be measured to determine the aperture angle. The sealing film should, therefore, show a clearly more marked permanent fold than the back wall.

When specifying the purposefully higher deformability of the sealing film in comparison with the back wall, the invention starts out from the consideration that for guaranteeing the desired high tightness especially in the margin area of front wall and back wall, where a larger part of the occurring untightnesses were found, additional sealing measures should be taken. Therefore, a sealing connection between front wall and back wall in their margin areas should be provided, which is, furthermore, adapted to a great extent to the general requirements imposed on the electrically active element. It should in particular be taken into account that the desired high tightness should also be guaranteed under greatly varying ambient conditions, in particular also under greatly varying ambient temperatures. Therefore, a suitably realized sealing element should be provided in the margin area between front wall and back wall, which, on they one hand, increases or safeguards the tightness of the system in the margin area, but is also able, on the other hand, to suitably compensate any changes of length or position arising due to different thermal expansions of front wall and back wall under varying ambient temperatures. For this purpose, it is provided to connect the front wall and the back wall in their margin areas with each other in a sealing manner through suitably chosen film elements, whereby the film to be used for this can also guarantee the compensation of thermally induced changes of length, thanks to a sufficiently high elasticity.

Advantageously, the adhesive tape forming the back wall is realized according to WO 2006067197, the carrier forming the back wall in including an upper film component consisting of at least one plastic film and the metallic layer component being arranged between the upper and the lower film component. Further advantageous embodiments of the adhesive tape forming the back wall can be taken from WO 2006067197, whose disclosure is completely integrated here in this respect, too.

Advantageously, the electrically active element is realized as an electrochromic element and is, therefore, particularly suitable for use in the field of motor vehicles. For this purpose, the electrically selectable layer system is advantageously realized as an electrochromic layer system, in a particularly advantageous embodiment, as a pure solid-state system.

In order to guarantee particularly favorable properties of the back wall regarding material compatibility on the one hand and sufficient tightness on the other hand, especially in combination with an electrochromic layer system, in particular a solid-state system, the upper and/or lower film component for the carrier forming the back wall advantageously consists in each case by a plastic film made of polypropylene, polyethylene, polyester or a compound of at least two of these, and/or the metallic layer component is formed by an aluminium layer. In view of specific applications, for example in the field of motor vehicles as rearview mirrors, the lower and upper film components each have in a further advantageous embodiment a thickness of about 20-100 μm, preferably of about 0-60 μm, very particularly preferably of about 52 μm, and the metallic layer component has a thickness of about 15-25 μm, preferably of about 18-25 μm, very particularly preferably of about 20 μm.

Due to the realization of the back wall as an adhesive tape and the gluing of the multilayer carrier over the whole surface of the electrically selectable layer system, a particularly intimate material contact and, therefore, a particularly high material adhesion and ruggedness of the entire component can be achieved, in particular in case of a compact construction. For this purpose, the glue material is applied on the outside of the lower film component of the carrier of the back wall advantageously in a mean thickness of about 20 to 102 μm, preferably of about 40 to 60 μm, very particularly preferably of about 42 μm.

In order to guarantee the desired tightness also and in particular in the margin area in a particularly reliable and efficient way, the film used there as a sealing element is in an advantageous embodiment also realized as a multilayer film. The latter comprises advantageously at least one upper film component consisting of at least one plastic film or lacquer, as well as a metallic layer component arranged under said upper film component. Said metallic layer component can be connected with the component under it, i.e. with partial areas of the back wall, with the substrate or with the strip conductor, by means of an applied glue, preferably consisting of EVA, acryl polyurethane. In an alternative advantageous embodiment, the film used as a sealing element includes in addition a lower film component, also consisting of at least one plastic film or lacquer, which together with the upper film component, in the manner of a sandwich structure, encloses the metal layer arranged between them. Also in this preferred embodiment, the lower film component can be connected with the component lying under it, i.e. with partial areas of the back wall, with the substrate or with the strip conductor, by means of an applied glue, preferably made of EVA, acryl, polyurethane. Advantageously, the upper and/or lower film component for the carrier forming the respective sealing element consists of a plastic film made of polyester, polypropylene, polyethylene or a compound of some of these materials.

In the above-mentioned advantageous embodiments, a particularly high tightness of the sealing film used can be achieved also in the area of the additionally provided margin sealing, which is guaranteed in particular by the metallic layer. The plastic films arranged on both sides of the metal layer shall serve in particular for electric insulation as well as for corrosion protection of the metal layer arranged between them as well as for the latter's mechanical protection. To also guarantee the desired relatively high elasticity, the thickness of the plastic film in these areas should preferably be relatively thin, maintaining at the same time the above-mentioned marginal conditions.

Especially in view of the preferably intended use of the electrically active element as an electrochromic element in a motor-vehicle mirror, dimensioning and material of tile components provided for margin sealing are advantageously also chosen in a suitable way. In this respect, it is provided as a particularly advantageous embodiment that the upper film component for the carrier forming the respective sealing element consists of a plastic film made of polyester and/or the metallic layer component consists of an aluminium layer. The glue used is preferably an EVA glue. As to the dimensioning, it is advantageously provided that the upper film component for the carrier forming the respective sealing element has a thickness of about 5-100 μm, preferably of about 10-30 μm, particularly preferably of about 12 μm, the metallic layer component has a thickness of about 5-100 μm, preferably of about 10-30 μm, particularly preferably of about 12 μm, and, if applicable, the lower film component has a thickness of about 5 to 100 ρm, preferably of about 10 to 30 μm, particularly preferably of about 12 μm.

Due to the whole-surface design, tight in itself, of the sealing elements based on films for the margin sealing, leakages are to be expected in general more or less only through diffusion through the gap formed between the film sealing or the respective sealing element and the element connected with each of them, i.e. the back wall on the one hand or the front wall on the other hand. A particularly high tightness can, therefore, be achieved, in a first approximation, already by a sufficiently large overlapping between the film sealing or the sealing element, of the one hard, and the respective other element, i.e. the flout wall or the back wall, on the other hand, by extending the diffusion path. To guarantee, moreover, a particularly high tightness, the above-mentioned gap areas are in a particularly advantageous embodiment provided with additional sealing elements for additional sealing.

In a first advantageous embodiment, the sealing film forming the respective sealing element is sealed for this purpose in a margin area against the front wall and/or the back wall by means of a glue/sealant bead. In another advantageous embodiment, the surface of the glue/sealant bead can be provided with a sealing layer. Glue/sealant beads of this type, and in particular with an additional sealing layer are described, for example, in the German patent application No. 10 2005 062 088.4, whose disclosure content regarding manufacture, design and material of the glue/sealant beads is expressly filly incorporated in the present disclosure by reference.

In a second, alternative or additional advantageous embodiment, a margin gap formed in a margin area between the sealing film forming the sealing element, on the one hand, and the front wall or the back wall, on the other hand, is filled with a glue filling, for the above-mentioned purpose of a particularly favorable sealing of the margin of the sealing element, the glue filling consisting advantageously of polyacrylate, polyurethane, epoxy EVA or a mixture of these components, in particular in view of the intended use as an electrochromic element in a motor-vehicle rearview mirror. In this way, the sealing film can be fixed in the margin area by means of the glue, but can otherwise be kept relatively movable, so that an improved sealing effect is already achieved due to the flexibility and insensitiveness to mechanical impairment achieved thereby. The increased movability of the sealing film can be achieved by the lack of glue or else by a glue between sealing film and substrate having a shear strength which is lower than that of the glue filling properly speaking.

An electrically active element which is particularly flexible and suitable for a great variety of applications is provided by another advantageous embodiment in which, on a margin strip of the front tall not covered by the back wall and the electrically selectable Layer system, a number of strip conductors is led which are covered in a sealing manner by one or several of the sealing elements. This facilitates a specific contacting of the electrically active layer system particularly well, it being possible to use the margin sealings in the manner of an additional function for protecting and covering the respective strip conductors. The combination of the strip conductors led on the margin area of the front wall with an electrically active layer system realized as a solid-state system is in this context particularly advantageous, because in this case, the thicknesses of the layer system, on the one hand, and the strip conductor, on the other hand, can be chosen in such a way that they are suitably adapted to each other, so that the margin sealing can fulfill the above-mentioned multiple purposes in a particularly efficient way. Advantageously, the strip conductor is at least 5 times thicker than the electrically selectable layer system.

To effect contacting and selection of the electrically active layer system from the periphery in a particularly expedient manner, the sealing film forming the sealing element includes in another advantageous embodiment a number of recesses for leading through conductor elements. To produce a sufficiently high tightness even at the spots of perforation, these recesses are advantageously sealed and/or insulated locally with glue material or sealing materials.

To consistently avoid any short circuits which might occur through the metallic film part of the sealing film in the area of contact with soldering joints or other conductive areas of the active element, the sealing film forming the sealing element advantageously includes a plurality of segments which are arranged laterally adjacent to each other and in such a way that their margin areas overlap, each of these segments being preferably provided with maximally only one conductor leadthrough, so that even if an electric contact of the metallic film part of this segment with the respective conductor occurs, a reliable electric insulation against the metallic film part of the adjacent segment and the elements possibly in conductive connection with it is guaranteed thanks to the overlapping of the margin area over tile upper or lower film consisting of non-conductive plastic.

To achieve an even better protection against short circus, it is guaranteed in another advantageous embodiment that each segment touches the possibly electrically conductive substrate with maximally one of its edges. For this purpose, advantageously at least one of the segments is arranged in the overlapping area with a first adjacent segment below that segment, and in the overlapping area with a second adjacent segment above that segment.

Advantageously, the electrically active element is realized as an electrochromic element, a transparent front glass, alternatively also made of a plastic material being provided as the front wall, and an electrochromic layer system, preferably as a solid-state system, being provided as the electronically selectable layer system. The electrically active element is preferably used in a motor-vehicle rearview mirror.

The advantages achieved with the invention consist in particular in the fact that by fixing between front wall and back wall of the electrically active element a margin sealing made of a sealing film which is more elastic or more easily deformable than the back wall, a particularly high tightness of the overall system, suitable even for everyday use in relatively adverse ambient conditions, can be achieved with a relatively simple construction. Especially due to the design of the margin sealing as a relatively elastic or easily deformable sealing film, even varying ambient conditions, such as, for example, relatively high temperature variations, can be taken into account, whereby even different thermal expansions of the front wall on the one hand and the back wall on the other hand can be compensated through the suitable elasticity of the margin sealing without loss in tightness.

Especially through the combination of a relatively rigid or thick back wall or back-wall film with a relatively deformable, more elastic and/or thinner sealing film in the lateral area, several actually contradictory design objectives can be taken into account: the film forming the back wall can be chosen with sufficient mechanical stability for being processed automatically, so that, for example, the formation of blisters during lamination is prevented. As this film is arranged directly on the active layer system, it also protects the latter against damage and pressure marks, which might lead to visible changes of the coloring dynamics and might, therefore, optically disturb the switching process. On the other hand, the sufficiently thin or elastic film of the margin sealing allows the latter to suitable adapt itself to the margin of the substrate and/or to the “margin topography”, so that, for example, a beading is possible.

### BRIEF DESCRIPTION OF THE DRAWINGS

An exemplary embodiment of the invention is explained in detail with reference to a drawing wherein:

FIG. 1 to 5 are each schematic representations of a detail in cross-section of an electrically active element, in particular an electrochromic element in a motor-vehicle mirror, and

FIGS. 6 and 7 each show a material test strip in a buckling test.

Identical parts are marked with the same reference numbers in all figures.

### DETAILED DESCRIPTION

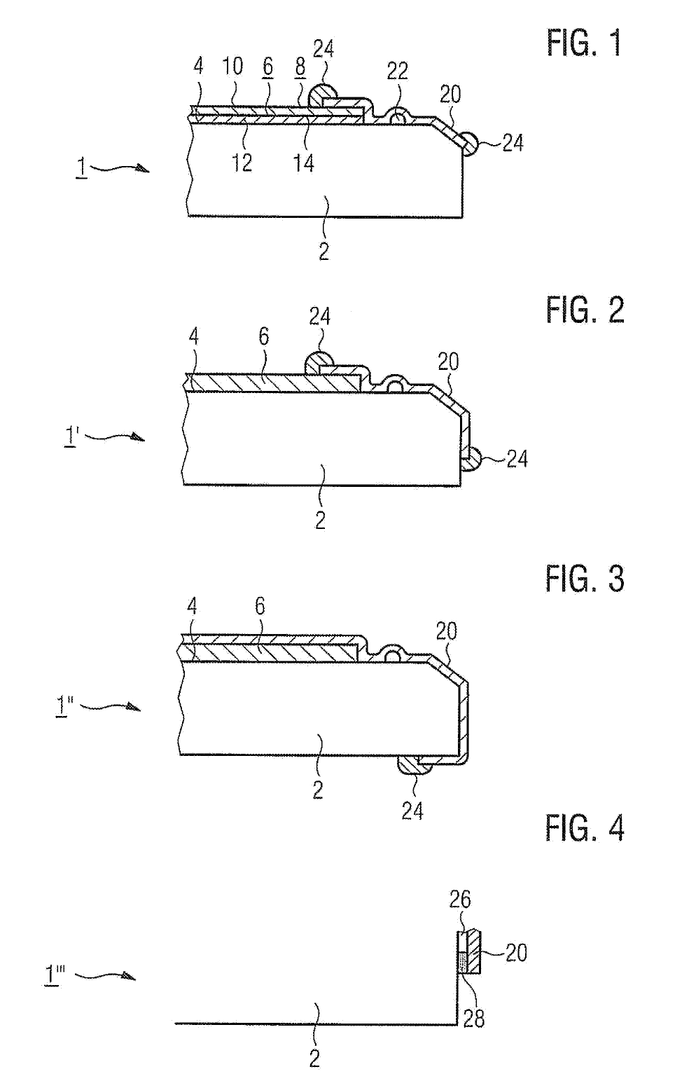

The electrically active element 1, 1′, 1″, 1′″ according to FIG. 1 to 4 is provided for use as an electrochromic element in a rearview mirror in a motor vehicle. It comprises in each case a transparent front glass as front wall 2, carrying in the manner of a substrate an electrochromic layer system 4 arranged thereon and the contacting necessary for it. Instead of the front glass, the front wall 2 could also be made of a plastic material.

In the exemplary embodiment, the electrochromic, electrically selectable layer system 4 is realized as a solid-state electrolytic system and comprises in particular, in a manner known per se and not shown in detail, an ion storage layer, a transparent solid-state electrolytic layer, an electrochromic electrode layer as well as a reflective layer. The electrochromic electrode layer can be formed in particular of molybdenum oxide, titanium oxide, vanadium oxide, niobium oxide, chromium oxide, manganese oxide, iron oxide, cobalt oxide, nickel oxide, rhodium oxide, tantalum oxide, iridium oxide and/or tungsten oxide and/or mixtures thereof, whereas the solid-state electrolytic layer can be formed, for example, of zirconium oxide, silicon oxide, aluminium oxide, selenium oxide and/or tantalum oxide. For forming the ion storage layer, iridium oxide, iridium-magnesium oxide, nickel oxide, nickel-magnesium oxide, manganese oxide, cobalt oxide, titanium-vanadium oxide and/or iridium-tantalum oxide can be used. Of course, other suitable materials can also be used for forming the above-mentioned layers of the electrochromic layer system 4; furthermore, a different number or sequence of the individual layers can be provided.

The back of the layer system 4 is covered by a back wall 6, a sealing film with a suitably chosen glue material being provided as back wall 6. The back wall 6 is executed as an adhesive tape with a multilayer carrier 8, including at least an upper film component 10 consisting of a plastic film and a lower film component 12 consisting of a plastic film, as well as a metallic layer component 14 arranged between the upper and lower film components 10, 12. On the outside of the lower film component 12, the carrier 8 is provided with a glue material which, after application of the back wall 6, lies directly on the layer system 4 and forms an intimate connection with it. For more simplicity, the above-mentioned structure of the back wall 6 is shown in detail in FIG. 1 only, but is realized in the same way in all other exemplary embodiments. Regarding manufacture, choice of material, further structure and the like, the back wall 6 is executed as an adhesive tape according to the disclosure of WO 2006067197, whose disclosure content is explicitly incorporated.

In view of the requirements, especially when used as a motor-vehicle rearview mirror, and in order to maintain reliable operating values, even under changing and adverse ambient conditions, the electrically active element 1, 1′, 1″, 1′″ is realized in such a way that the electrochromic layer system 4 is sufficiently sealed against the environment or surroundings. For this purpose, on the one hand, the front wall 2 and the back wall 6 are suitably chosen in such a way that they possess a sufficiently high tightness over the whole surface, so that water, solvents or the like cannot penetrate through them into the layer system 4 arranged between them. To guarantee a sufficiently high tightness over the whole surface, the upper and/or lower film components 10, 12 for the carrier 8 forming the back wall 6 are formed by a plastic film consisting of polyester, and/or the metallic layer component 14 is formed by an aluminium layer. Especially in view of the intended applications as an electrochromic element in a motor vehicle rearview mirror, the dimensions are suitably chosen, the lower and upper film components 12, 10 each having a thickness of about 52 μm and the metallic layer component 14, a thickness of about 20 μm whereas the glue material not shown in detail in FIG. 1 is applied with a mean thickness of about 50-60 μm. To safeguard, however, the necessary tightness also and especially in the margin areas where the back wall 6 rests on the front wall 2 with formation of a gap, the electrically active element 1 is provided on its outer periphery with a number of sealing elements 20, which connect the front wall 2 and the back wall 6 in a sealing manner.

The sealing elements 20 are specifically designed for reliably fulfilling two actually contradictory design objectives. Namely, on the one hand, the sealing elements are designed for reacting in a relatively elastic manner, even in case of local changes of position of the back wall 6 relative to the front wall 2, which may occur especially in the margin areas, for example, due to stresses as a consequence of thermal expansion or contraction, due to mechanical stresses or due to absorption of humidity. Accordingly, the seeing elements 20 are designed for a sufficiently high mechanical deformability to compensate the above-mentioned stresses. One the other hand, however, the sealing elements 20 are also designed for maintaining a sufficiently high tightness even under such occuring deformations.

In order to reliably fulfill these actually contradictory design objectives, the sealing elements 20 for their part are realized as sealing films, the respective sealing film being chosen such that it is more flexible or deformable and/or has more elastic properties than the back wall 6. This can be achieved, for example, by choosing a suitable material and/or through a suitable dimensioning, in particular a relatively thin realization of the sealing film used as a sealing element 20.

In particular, one understands by “deformable” “permanently deformable”. In the exemplary embodiment, it is specifically guaranteed, among others, trough the choice of a suitable material and dimensioning of the sealing or margin-sealing film used as a sealing element 20, that due to their particular deformability a permanent deformation is produced during fixing or manufacturing of the element, which supports or at least does not hinder the desired sealing effect. For this purpose, the sealing film is designed in such a way, especially in comparison with the relatively rigid back wall 6, that, after having been folded over through loading with a test weight and subsequent release, it shows a developing aperture angle of not more than half of the aperture angle of the back wall under comparable test conditions. In other words, them sealing film shall he constituted and dimensioned in such a way that after having been folded over about the margin area, it shows a clearly lower tendency to stand up again than the back wall, which is finally expressed in the before-mentioned aperture angle.

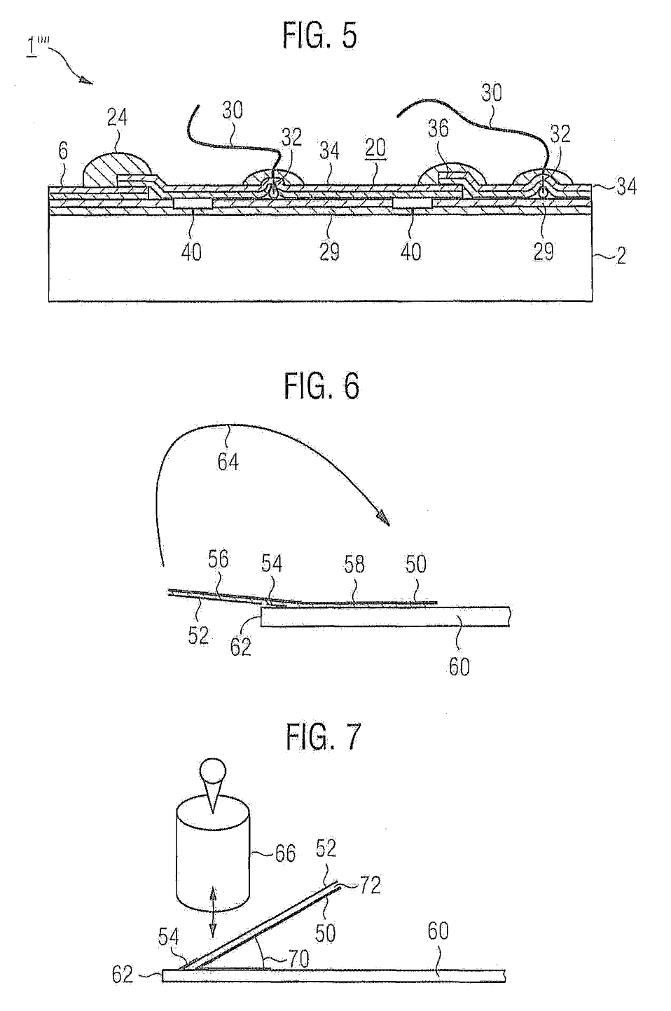

To verify these properties, the sealing film on the one hand and the back-wall material on the other hand can be subjected to a suitable laboratory test under otherwise identical test conditions, whose phases are schematically shown in FIGS. 6 and 7. In such a laboratory test, for example, the liner 52 of the adhesive tape is removed from a test strip 50 of the material to be examined, i.e. of the sealing film or of the back wall, of a specifiable dimension of 40 mm length and 9 mm width over a length of 23 mm. Then, a strip 54 of about 3 mm width and at least 9 mm length of the liner 52 is separated and applied on the glue material of the test strip 50 in such a way that the test strip 50 is in a first area 56 provided with the liner 52 over a length of 20 mm and in a second area 58, free of liner 52 over a length of 20 mm. The test strip 50 prepared in this way is then glued with its exposed glue material on a glass plate 60 in such a way that 15 mm of its portion provided with liner 52 protrude over the margin 62 of the glass plate. This portion is then lifted and pulled in the direction of the glued-on portion of the strip, as indicated in FIG. 6 by the arrow 64, and then, a test weight of about 1500 g is put on obliquely from outside in such a way that the end of the glued-on portion of the test strip 50 is folded over backwards. In the exemplary embodiment, the test weight 66 is realized as a substantially cylindrical body with a diameter of 100 m. It is put on in such a way that during the loading, its center is situated 15 mm behind the end of the strip, so that in the load stage, the edges of the test weight 66 are situated 65 mm behind the end of the strip, respectively 15 mm in front of the fold.

After the test weight 66 has remained in this position during a load stage of at least about 5 minutes, it it taken off upwards, as indicated in FIG. 7. Then, the 3 mm wide separate strip 54 of the liner 52 is pulled off the glue material without deformation of the test strip 50, so that the liner 52 taken off in the folding area will not be upset while the test strip 50 rises, thus hindering its rising. After a specifiable relaxation time of, for example, some minutes or some hours, the height of the risen free end 72 of the test strip is measured to determine the aperture angle 70. The sealing film should, therefore, show a clearly more marked permanent fold than the back wall 6, whereby the aperture angle 70 of the back, wall 6 should be at least double the aperture angle 70 of the sealing film.

For the exemplary embodiments defined in the following, an aperture angle 70 of 76° was determined in this lest for die back wall 6 and of 2°, for the sealing film, with a load stage of 5 minutes, and an aperture angle 70 of 77° for die back wall 6 and of 2°, for the sealing film, with it load stage of 30 minutes.

To achieve a sufficiently high sealing effect, the respective sealing element 20 is also realized, analogously to the back wall 6, as a multilayer film comprising at least one upper and one lower film component, each of them formed by at least one plastic film, as well as a metallic layer component arranged between the upper and lower film components. For the respective sealing element 20, the upper film component consists of a plastic film made of EVA glue, the metallic layer component, of an aluminium layer and the lower film component, of a plastic film made of polyester. The upper film component has a thickness of about 12 μm and the metallic layer component has a thickness of about 12 μm.

In addition, on a margin strip of the front wall 2 which is not covered by the back wall 6 and the electrically selectable layer system 4, a number of strip conductors 22 are led, which are also covered in a sealing manner by the respective sealing elements 20. These strip conductors can in particular suitably be led for suitable contacting of the layer systems 4, the covering through the sealing elements 20 also guaranteeing, in the manner of a double function, sufficient protection of the strip conductors 22 against damage or pollution.

As to their constitution, material and the like, the sealing elements 20 are realized for a particularly high sealing effect of the margin area between the front wall 2 and the back wall 6. In addition to the sealing effect properly speaking of the respective sealing element 20, it can be provided that the sealing film forming the respective sealing element 20 is sealed in a margin area by means of a glue/sealant bead 24, as shown in the exemplary embodiments according to FIG. 1 to 3 gezeigt ist.

The glue/sealant bead 24 is made of a suitably chosen, sufficiently elastic material, such as, for example, a glue/sealant based on acrylate or epoxy or urethane, such as, for example, polyacrylate, polyurethane, epoxy or EVA. Furthermore, the surface of the respective glue bead 24 is provided in the exemplar embodiment with a sealing layer. Such a glue bead provided with a sealing layer is known from the German patent application No. 10 2005 062088.4, not published earlier, whose disclosure regarding type, constitution and manufacture of the glue/sealant beads is fully incorporated in the present disclosure.

In addition to the provision of the glue/sealant beads 24, the respective sealing element 20 can also be suitable dimensioned to achieve a sufficient tightness of the coverall system, based in particular on the knowledge that in view of the tightness of the sealing film used, any remaining leakages will substantially be due to diffusion processes between the respective sealing element 20 and the front wall 2 or the back wall 6. To extend the diffusion paths and increase the sealing effect accordingly, the overlapping between the respective sealing element 20 and the front wall 2 or the back wall 6 can be realized over a suitably large surface. For example, the exemplary embodiment according to FIG. 2 shows, as compared with the exemplary embodiment according to FIG. 1, that the sealing element 20 can be pulled around an edge of the front wall 2 up to and into the latter's margin area, whereas in the exemplary embodiment according to FIG. 3, the sealing element 20 is pulled around the two edges up to the rear side of the front wall 2, the overlapping with the back wall 6 having also been chosen relatively big. In particular in the exemplary embodiment according to FIG. 3, the sealing element 20 is realized in such a way that is covers the whole surface of the back wall 6 and also connects the other end of the back wall 6, which is not visible in the figure, in a sealing manner with the front wall 2.

Alternatively or additionally, as shown in FIG. 4, a margin gap 26 formed in a margin area between the sealing film forming the sealing element 20, on the one hand, and the front wall 2 or the back wall 6, on tile other hand, can be filled with a glue filling 28, which may complete or replace, in view of the sealing effect, the glue bead 24. In the exemplary embodiment, the glue filling 28 consists of polyacrylate, polyurethane, epoxy, EVA or a mixture of these components.

In the exemplary embodiment according to FIG. 5, the electrically active element 1″″ is specifically designed for avoiding short circuits in the strip conductors 22 or conductive layers positioned under the sealing element 20 and in particular between conduction areas 29 which are laterally insulated and electrically separated from each other through separation points 40. Among others, it has been taken into account that for contacting these conductive areas below the sealing elements 20, lead wires or conductor elements 30 are provided which are lead through the sealing film forming the sealing element 20 at suitable spots. For leading these conductor elements 30 through, the sealing film forming the sealing element 20 is provided with a number of recesses 32.

In such an arrangement, undesired short circuits might occur between different conduction areas 29, if the conductor elements 30 get into electrically conductive contact with the metallic film part of the sealing film forming the sealing element 20, in the area of the respective recesses 32. To reliably avoid such short circuits, the sealing film forming the sealing element 20 is of a segmented design and includes a plurality of segments 34 which are arranged laterally adjacent to each other and in such a way that their margin areas 36 overlap, each of these segments 34 being provided with maximally one recess 32 only. Therefore, even if an electric contact of the metallic film part of this segment 34 with the respective conductor element 30 occurs, a reliable electric insulation against the metallic film part of the adjacent segment and the elements possibly in conductive connection therewith is guaranteed duce to the overlapping of the margin area 36 over the upper or lower film consisting of non-conductive plastic.

Furthermore, the segment 34, which is the left-hand one in the representation according to FIG. 5 is arranged in the overlapping area with a first adjacent segment 34 below the latter and in the overlapping area with the back wall 6, above the latter, so that in cross-section, the segment 34 has an approximately z-shaped structure. In this way, it is guaranteed, for an even better protection against short circuits, that each segment 34 touches the possibly electrically conductive substrate with maximally one of its edges.

1-24. (canceled)

25. An electrically active element comprising:
a front wall;
a back wall including tin adhesive tape with a multilayer carrier including a lower film component of at least one plastic film and a metallic layer component disposed on the lower film component and an adhesive material disposed on an outer surface of the film component;
an electrically selectable layer system disposed between the front wall and the back wall; and
a plurality of sealing elements including a sealing film that is more deformable than the back wall, wherein edge areas of the front wall and the back wall are connected in a sealing manner using the plurality of seating elements.

26. The electrically active element as recited in claim 25 wherein, after folding the sealing film via loading with a test weight and subsequently releasing it, the sealing film shows a developing aperture angle of not more than half of an aperture angle of the back wall under comparable test conditions.

27. The electrically active element as recited in claim 25, wherein the carrier forming the back wall includes an upper film component of at least one plastic film, and wherein the metallic layer component is disposed between the upper and the lower film components.

28. The electrically active element as recited in claim 25,
wherein the sealing film has a first modulus of elasticity, and a first thickness,
wherein the back wall has a second modulus of elasticity and a second thickness, and wherein a product E·a³ of the first modulus of thickness and a third power of the first thickness is at least two times smaller than a product of the second modulus of elasticity and a third power of the second thickness.

29. The electrically active element as recited in claim 25, wherein the electrically selectable layer system includes an electrochromic layer system.

30. The electrically active element as recited in claim 25, wherein at least one of the upper and lower film components of the carrier forming the back wall is formed by a plastic film made of polypropylene, polyethylene, polyester or compounds of these materials, and/or the metallic layer component is formed by an aluminium layer.

31. The electrically active element as recited in claim 30, wherein the lower and upper film components each have a thickness of about 20 to 100 μm, and the metallic layer component has a thickness of about 10 to 25 μm.

32. The electrically active element as recited in claim 25, wherein the adhesive material has a mean thickness of about 20 to 120 μm.

33. The electrically active element as recited in claim 25, wherein each sealing element includes a multilayer film having at least one sealing upper film component of at least one plastic film, as well as a sealing metallic layer component arranged under the sealing upper film component.

34. The electrically active element as recited in claim 33, wherein each sealing element includes a sealing lower film component of at least one plastic film, the sealing metallic layer component being arranged between the sealing upper and sealing lower film components.

35. The electrically active element as recited in claim 34, wherein the sealing upper or sealing lower film component is formed by a plastic film made of polyester, polypropylene, polyethylene, and/or the metallic layer component is formed by aluminium layer.

36. The electrically active element as recited in claim 25, wherein each sealing element is fixed to the respective component lying locally under it, by means of a glue layer.

37. The electrically active element as recited in claim 34, wherein the sealing upper film component has a thickness of about 5 to 100 μm, the sealing metallic layer component has a thickness of about 5 to 100 μm, and the sealing lower film component has a thickness of about 5 to 100 μm.

38. The electrically active element as recited in claim 25, wherein the sealing film is sealed in an edge area against at least one of the front wall and the back wall using a glue/sealant bead.

39. The electrically active element as recited in claim 38, wherein a surface of the glue/sealant bead is provided with a sealing layer.

40. The electrically active element as recited in claim 25 wherein a margin gap formed in the edge area between the sealing film and at least one of the front wall and the back wall is provided with a glue filling.

41. The electrically active element as recited in claim 40, wherein the glue filling is made of polyacrylate, polyurethane, epoxy, EVA or a mixture of these components.

42. The electrically active element as recited in claim 25, wherein a strip conductor covered in a sealing manner by one or several of the scaling elements is disposed on a margin strip of the front wall, which is not covered by the back wall and the electrically selectable layer system.

43. The electrically active element as recited in claim 43, wherein a thickness of the strip conductor is at least 5 times greater than a thickness of the electrically selectable layer system.

44. The electrically active element as recited in claim 25, wherein the sealing film includes a plurality of recesses each configured to receive a conductor element.

45. The electrically active element as recited in claim 25, wherein the sealing film includes a plurality of segments arranged laterally adjacent to each other and arranged such that edge areas of each of the segments overlap.

46. The electrically active element as recited in claim 45, wherein at least one of the segments is arranged over a first adjacent segment in a first edge area and under a second adjacent segment in a second edge area.

47. An electrochromic element including an electrically active element according to claim 25, wherein the front wall includes a transparent front glass and the electrically selectable layer system includes an electrochromic layer system.

48. A motor-vehicle mirror having an electrically active element according to claim 25.
